(19) United States
(12) Patent Application Publication
(10) Pub. No.: US 2017/0344933 A1
(43) Pub. Date: Nov. 30, 2017

(54) METHOD AND SYSTEM FOR MANAGING SUPPLY CHAIN WITH VARIABLE RESOLUTION

(71) Applicant: Caterpillar Inc., Peoria, IL (US)

(72) Inventors: Anthony James GRICHNIK, Eureka, IL (US); Karunya JASTI, Dunlap, IL (US); Santhosh Viswanath VAMARAJU, Morton, IL (US); Lusine BAGHDASARYAN, Lake Forest, IL (US); Nichole Anne ALTON, Tremont, IL (US); Adam Daniel BYERLY, East Peoria, IL (US); Marco VELUSCEK, Middlesex (GB)

(73) Assignee: Caterpillar Inc., Peoria, IL (US)

(21) Appl. No.: 15/167,372

(22) Filed: May 27, 2016

(51) Int. Cl. G06Q 10/08; G06Q 10/06

(52) U.S. Cl. CPC G06Q 10/083; G06Q 10/0631

(57) ABSTRACT

A method for managing a supply chain may include acquiring property data regarding the supply chain, acquiring one or more objectives to be achieved by the supply chain, the supply chain including a plurality of supply chain entities including customers, manufacturing facilities, and distributing facilities, and a plurality of edges connecting the supply chain entities. The method may also include establishing a first supply chain model for the supply chain in a first geographic resolution based on the property data, determining a first solution for the first supply chain model, establishing a second supply chain model for the supply chain in a second and finer geographic resolution based on the first solution, determining a second solution for the second supply chain model, manufacturing products by manufacturing facilities based on the second solution, and distributing the manufactured products by the distributing facilities and edges based on the second solution.

### TECHNICAL FIELD

This disclosure relates generally to systems and methods for managing a supply chain and, more particularly, to systems and methods for managing a supply chain with variable resolution.

### BACKGROUND

Supply chain planning may be essential to the success of many of today's companies. Most companies rely on supply chain planning to ensure timely and reliable delivery of products in response to customer demands. Conventional supply chain planning techniques use various numeric methods to model functioning of different aspects of a supply chain, from the manufacturing of products at various manufacturing facilities to the transportation of the finished products from the manufacturing facilities to various customers to meet the customer demands.

For example, U.S. Patent Publication No. 2015/0046363 A1 (“the '363 publication”) discloses an engineering, manufacturing, supply chain, and logistics operation management platform that can configure factors of product development, production, supply chains, and logistic operations and dynamically control such factors, supply chain and logistics to optimize performance. The platform includes a supply chain and logistic analyzer which can identify problems or choke points or bottlenecks in the supply chain and/or logistics operation(s) and/or provide recommended changes to the supply chain and/or logistics operation(s) to provide greater resilience, more reliable and faster material and/or part and/or component and/or product manufacture and delivery cycles, higher inventory turns, and reduced cost and waste simultaneously.

The method disclosed in the '363 publication may be useful to generate supply chain and logistic operation solutions. However, some supply chains may include many supply chain entities and thus have very complex structures, and the method disclosed in the '363 publication may not be able to efficiently generate supply and distribution solutions for the supply chains in a relatively short period of time with limited computing resources.

The supply chain management system of the present disclosure is directed toward solving the problem set forth above and/or other problems of the prior art.

### SUMMARY

In one aspect, the present disclosure is directed to a method for managing a supply chain. The method may include acquiring property data regarding the supply chain. The supply chain may include a plurality of supply chain entities including a plurality of customers with demands for products, a plurality of manufacturing facilities for manufacturing the products, and a plurality of distributing facilities for distributing the products from the manufacturing facilities to the customers, and a plurality of edges connecting the plurality of supply chain entities. The method may also include acquiring one or more objectives to be achieved by the supply chain, establishing a first supply chain model for the supply chain in a first geographic resolution based on the property data, determining a first solution for the first supply chain model to fulfill demands and achieve the one or more objectives, establishing a second supply chain model for the supply chain in a second and finer geographic resolution based on the first solution for the first supply chain model, determining a second solution for the second supply chain model to fulfill the demands and achieve the one or more objectives, manufacturing products by the manufacturing facilities based on the second solution, and distributing the manufactured products by the distributing facilities and edges based on the second solution.

In another aspect, the present disclosure is directed to a supply chain. The supply chain may include a plurality of supply chain entities including a plurality of customers with demands for products, a plurality of manufacturing facilities for manufacturing the products, and a plurality of distributing facilities for distributing the products from the manufacturing facilities to the customers, and a plurality of edges connecting the plurality of supply chain entities. The supply chain may also include a processor configured to acquire property data regarding the supply chain, acquire one or more objectives to be achieved by the supply chain, establish a first supply chain model for the supply chain in a first geographic resolution based on the property data, determine a first solution for the first supply chain model to fulfill demands and achieve the one or more objectives, establish a second supply chain model for the supply chain in a second and finer geographic resolution based on the first solution for the first supply chain model, and determine a second solution for the second supply chain model to fulfill the demands and achieve the one or more objectives. The manufacturing facilities may be configured to manufacture based on the second solution. The distributing facilities and edges may be configured to distribute the manufactured products based on the second solution.

In yet another aspect, the present disclosure is directed to a supply chain management system for managing a supply chain. The supply chain may include a plurality of supply chain entities including a plurality of customers with demands for products, a plurality of manufacturing facilities for manufacturing the products, a plurality of distributing facilities for distributing the products from the manufacturing facilities to the customers, and a plurality of edges connecting the plurality of supply chain entities. The system may include a processor and a non-transitory memory configured to store instructions that, when executed, enable to the processor to: acquire property data regarding the supply chain, acquire one or more objectives to be achieved by the supply chain, establish a first supply chain model for the supply chain in a first geographic resolution based on the property data, determine a first solution for the first supply chain model to fulfill demands and achieve the one or more objectives, establish a second supply chain model for the supply chain in a second and finer geographic resolution based on the first solution for the first supply chain model, determine a second solution for the second supply chain model to fulfill the demands and achieve the one or more objectives, instruct the manufacturing facilities to manufacture products based on the second solution and instruct the distributing facilities to distribute the manufactured products based on the second solution.

### BRIEF DESCRIPTION OF THE DRAWINGS

FIG. 1 illustrates an exemplary supply chain in which the supply chain management system consistent with the disclosed embodiments may be implemented.

FIG. 2 illustrates an exemplary supply chain management system consistent with certain disclosed embodiments.

FIG. 3 illustrates a flow chart of an exemplary process for supply chain management, consistent with a disclosed embodiment.

FIG. 4 illustrates a flow chart of an exemplary process for establishing a first supply chain model, consistent with a disclosed embodiment.

FIG. 5 illustrates a plurality of first cells and a supply chain, consistent with a disclosed embodiment.

FIG. 6 illustrates an exemplary first supply chain model, consistent with a disclosed embodiment.

FIG. 7 illustrates an exemplary first solution of the first supply chain model of FIG. 6, consistent with a disclosed embodiment.

FIG. 8 illustrates a flow chart of an exemplary process for establishing a second supply chain model, consistent with a disclosed embodiment.

FIG. 9 illustrates a plurality of second cells, a plurality of first cells, and a supply chain, consistent with a disclosed embodiment.

FIG. 10 illustrates an exemplary second supply chain model, consistent with a disclosed embodiment.

FIG. 11 illustrates an exemplary second solution of the second supply chain model of FIG. 10, consistent with a disclosed embodiment.

### DETAILED DESCRIPTION

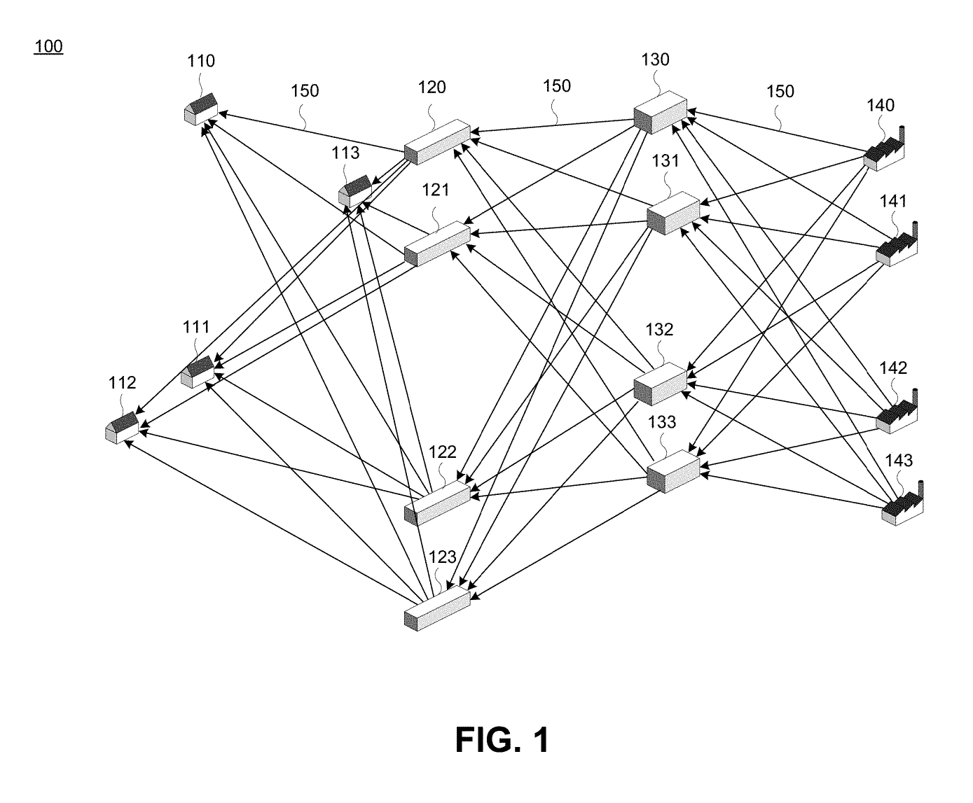

FIG. 1 illustrates an exemplary supply chain 100 in which the supply chain management system consistent with the disclosed embodiments may be implemented. As shown in FIG. 1, supply chain 100 may include a plurality of supply chain entities, such as customers 110-113, distributing facilities 120-123 and 130-133, and manufacturing facilities 140-143. Supply chain 100 may also include a plurality of edges 150 connecting the supply chain entities.

Customers 110-113 may be located in different geographic locations and may have different demands for one or more products. In some embodiments, one or more customers 110-113 may be dealers that demand products for sale to end-customers. A product, as used herein, may represent any type of finished goods that is manufactured or assembled by manufacturing facilities 140-143 The product may include one or more components, parts, or materials supplied from one or more component suppliers. Non-limiting examples of the products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of movable machine that operates in a work environment.

Manufacturing facilities 140-143 may be located in different geographic locations and may manufacture or assemble products by using one or more individual components supplied from one or more component suppliers. Manufacturing facilities 140-143 may supply the manufactured products to customers 110-113. The products manufactured by manufacturing facilities 140 and 141 may be identical, or may be different from each other. Manufacturing facilities 140-143 may respectively deliver the manufactured products to customers 110-113 via one or more distributing facilities 120-123 and 130-133, or directly to one or more customers 110-113.

Distributing facilities 120-123 and 130-133 may include inbound distributing facilities 120-123 and outbound distributing facilities 130-133. Outbound distributing facilities 130-133 may receive products manufactured by manufacturing facilities 140-143, and may distribute the products to inbound distributing facilities 120-123. Inbound distributing facilities 120-123 may then distribute the products to customers 110-113 for sale as individual products. For example, inbound distributing facilities 120-123 may be transition seaports along the coast line of a continent (e.g., North America) where customers 110-113 are located, and outbound distributing facilities 130-133 may be transition seaports along the coast line of another continent (e.g., Europe) where manufacturing facilities 140-143 are located. In some embodiments, manufacturing facilities 140-143 may directly deliver the manufactured products to customers 110-113, e.g., over land, without passing through distributing facilities 120-123 and 130-133. Additionally, distributing facilities 120-123 and 130-133 need not be separated by a body of water; they may simply represent waypoints such as railheads along a supply network distributed completely over a contiguous piece of land.

The plurality of edges 150 may represent possible flow of materials, such as components and products, from one supply chain entity to another. Each one of customers 110-113 is connected with at least one of manufacturing facilities 140-143 by one or more edges 150 that form one or more routes. For example, as illustrated in FIG. 1, customer 110 is connected with inbound distributing facility 120, outbound distributing facility 130, and manufacturing facility 140 by edges 150 to form a route for delivering products from manufacturing facility 140 to customer 110.

Although supply chain 100 includes supply chain entities such as four customers 110-113, four inbound distributing facilities 120-123, four outbound distributing facilities 130-133, and four manufacturing facilities 140-143, those skilled in the art will appreciate that supply chain 100 may include any number of these supply chain entities.

Further, although supply chain 100 includes only one supply layer consisting of manufacturing facilities 140-143, those skilled in the art will appreciate that the depth of supply chain 100, i.e., the number of supply layers in supply chain 100 is not limited, and supply chain 100 can extend to include any number of supply layers. For example, supply chain 100 may include an additional supply layer consisting of component suppliers for supplying components required by manufacturing facilities 140-143 for manufacturing products. Therefore, the depth of a supply chain model is not limited, as long as data regarding the supply layers in the supply chain is available and the suppliers (e.g., manufacturing facilities, component suppliers, etc.) in the supply layers are controllable.

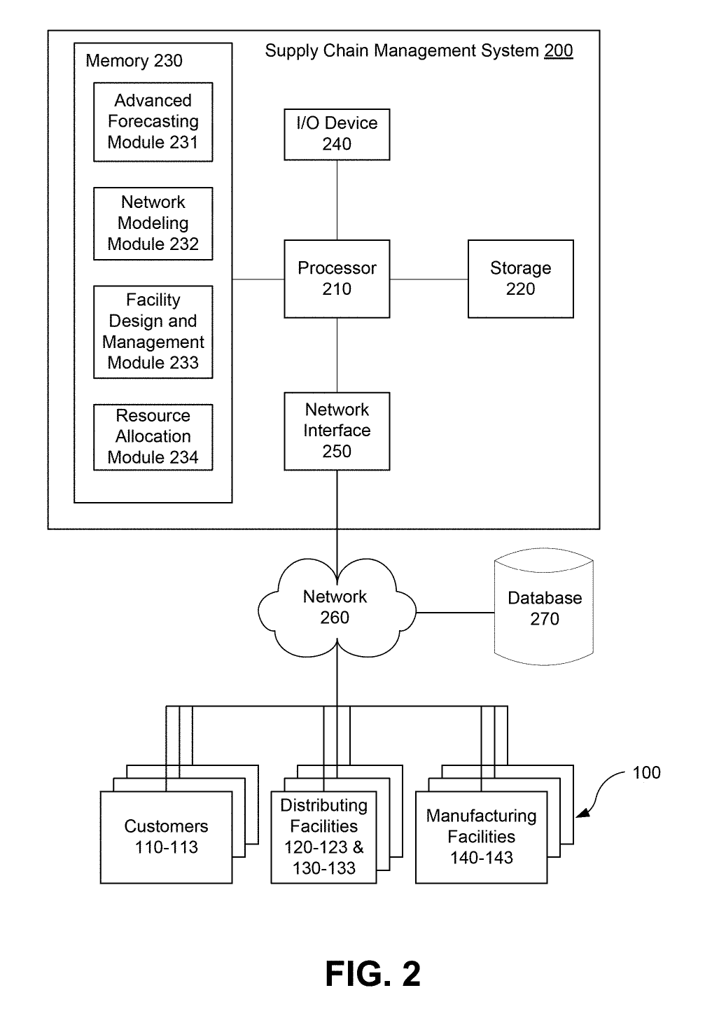

When customers 110-113 make demands for products, supply chain 100 may be managed to fulfill the demand. The management of supply chain 100 may include designing and managing production plans at each one of manufacturing facilities 140-143, designing and managing the flow of products between the supply chain entities, and the positioning of inventory at key locations as required to meet one or more supply chain objectives. The supply chain 100 may be designed according to a plurality of objectives including, for example, minimizing inventory cost, maximizing profit of the business, minimizing time taken to fulfill the demand, minimizing environmental impact, maximizing resilience of the network, minimizing total route distance, etc. The management may be carried out according to disclosed embodiments by an exemplary system as shown in FIG. 2.

FIG. 2 illustrates an exemplary supply chain management system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to supply chain management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as customers 110-113, distributing facilities 120-123 and 130-133, and manufacturing facilities 140-143. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, capacity data, and the like. In addition, one or more constituent components of system 200 may be co-located with any one of the supply chain entities.

Processor 210 may include one or more processing devices, such as one or more microprocessors from the CORE™ or XEON™ family manufactured by INTEL™, the ATHLON™ family manufactured by AMD™, the CUDA™-enabled processors manufactured by NVIDEA™, or any other type of processors. As shown in FIG. 2, processor 210 may be communicatively coupled to storage 220, memory 230, I/O device 240, and network interface 250. Processor 210 may be configured to execute computer program instructions to perform various processes and method consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, and a facility design and management module 233.

Advanced forecasting module 231 may generate forecast information related to one or more items at any one of the supply chain entities based on historical data associated with the item. For example, advanced forecasting module 231 may forecast a future demand for a product at each one of customers 110-113 based on historical demand data for that product at the customer 110-113. In addition, advanced forecasting module 231 may forecast the future demand for the product at each one of manufacturing facilities 140-143 based on the forecasted demand for the product at each one of customers 110-113 and distribution routes for distributing products from manufacturing facilities 140-143 to customers 110-113.

Network modeling module 232 may receive the forecasted information from advanced forecasting module 231 and simulate and optimize the flow of materials (e.g., products and components) and placement of inventories between the supply chain entities and the structure of supply chain 100 in order to meet certain business goals or objectives of the entire organization. The business goals or objectives may include at least one of response time, costs, profit, return on net assets, inventory turns, inventory level, service level, resilience of the supply chain network, costs, environmental impact, total route distance, etc. Network modeling module 232 may simulate the flow of materials and optimize the structure of the supply chain network based on a number of parameters, such as geographical locations of each one of the supply chain entities, the mode of transport (e.g., air, ship, truck, etc.), the transport capacities at the edges (e.g., quantity of materials that can be transported via a certain route), and the manufacture capacities at the manufacturing facilities. Based on the simulation results and other information such as production costs, transport costs, and regional sales price, and the like, network modeling module 232 may generate information such as gross revenue, cost of goods sold, profit, and carbon emissions related to one or more products or parts.

Network modeling module 232 may further generate an optimized structure of the supply chain network based on the parameters and information discussed above. The optimized structure of the supply chain network may specify, for example, the links among the entities used to fill the demand for the product, the modes of transport used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of the supply chain entities based on the received information. For example, facility design and management module 233 may receive forecasted information representing quantity of the incoming items to be received at distributing facilities 120-123 and 130-133 and manufacturing facilities 140-143. Based on this forecasted information, facility design and management module 233 may determine dimensions and locations of shelving, racks, aisles, and the like, of distributing facilities 120-123 and 130-133 and manufacturing facilities 140-143. Facility design and management module 233 may also determine the location of incoming items within distributing facilities 120-123 and 130-133 and manufacturing facilities 140-143 based on the forecasted information. Moreover, facility design and management module 233 may simulate the movement of resources (e.g., workers, machines, transport vehicles, etc.) throughout distributing facilities 120-123 and 130-133 and manufacturing facilities 140-143 over time. Still further, facility design and management module 233 may modify input information in order to achieve one or more of the business goals.

I/O device 240 may include one or more components configured to communicate information associated with system 200. For example, I/O device 240 may include a console with an integrated keyboard and mouse to allow a user to input parameters associated with system 200 and/or data associated with supply chain 100. I/O device 240 may include one or more displays or other peripheral devices, such as, for example, printers, cameras, microphones, speaker systems, electronic tablets, bar code readers, scanners, or any other suitable type of I/O device 240.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production plans, production costs, and resources. The data stored in database 270 may be used by processor 210 to receive, categorize, prioritize, save, send, or otherwise manage data associated with logistics network management.

In one embodiment, system 200 may be a cloud server that uses dynamic and extensible services through the Internet. That is, the cloud server may collect and populate information related to supply chain 100 via Internet, and may display, store, analyze, evaluate, distribute, report, process, record, and/or sort information related to supply chain management by using Internet-based computational resources. In addition, database 270 may be a cloud-based storage device that stores information related to supply chain 100 on Internet.

### INDUSTRIAL APPLICABILITY

The disclosed supply chain management system 200 may efficiently provide optimized supply chain designs for any business organization to achieve one or more desired business goals or objectives. When a supply chain includes too many supply chain entities and edges, it will take a long time for a computer to find an optimized design for the supply chain using conventional methods. However, based on the disclosed system and methods, supply chain management system 200 can provide the optimized supply chain design within a relative short time by using variable resolutions.

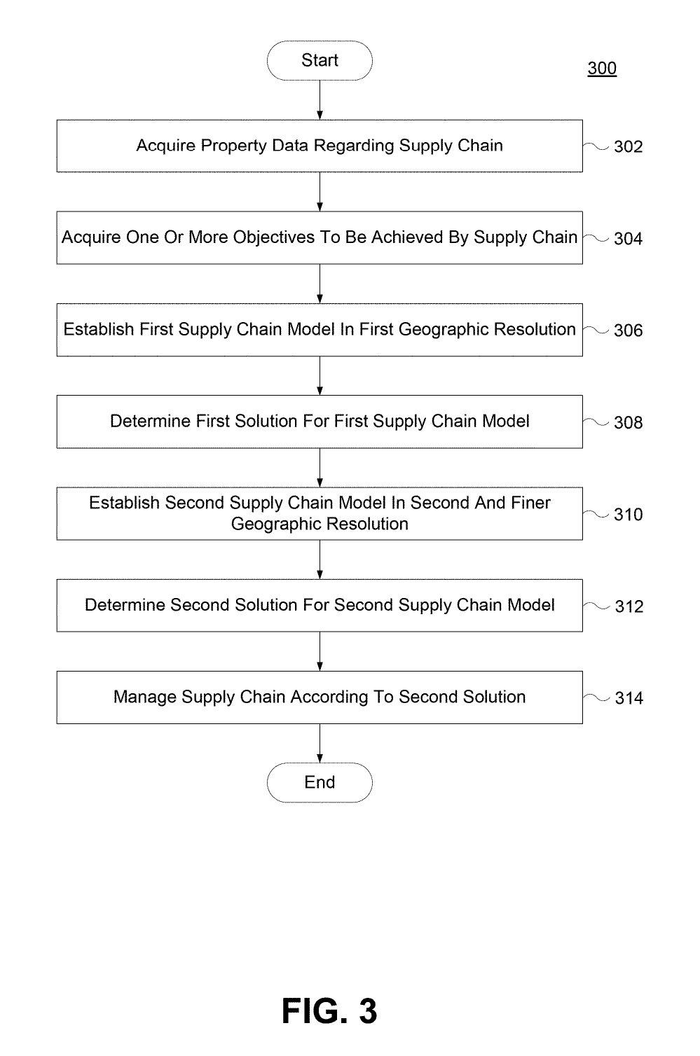

FIG. 3 illustrates a flow chart of an exemplary process 300 for supply chain management, consistent with a disclosed embodiment. Process 300 may be implemented by processor 210 of system 200. Process 300 may be used to manage supply chain 100 illustrated in FIG. 1.

According to FIG. 3, processor 210 may first acquire property data regarding supply chain 100 at step 302. Processor 210 may acquire the property data via user input, or from database 270 or storage 220. The property data may include property data of the materials (e.g., products and components) involved in supply chain 100. For example, the property data of a product may include the size and weight of the product and sales price of the product at each one of customers 110-113. The property data of a component may include the size and weight of the component.

The property data may also include property data of each one of the supply chain entities, such as customers 110-113, distributing facilities 120-123 and 130-133, and manufacturing facilities 140-143. For example, the property data may include geographic locations of each supply chain entity, demands (i.e., number of products demanded for each future month) at each one of customers 110-113, manufacturing capacity, manufacturing time, and manufacturing cost at each one of manufacturing facilities 140-143, inventory cost at each one of customers 110-113, distributing facilities 120-123 and 130-133, and manufacturing facilities 140-143, transport capacity at each one of distributing facilities 120-123 and 130-133, and environmental impact of each supply chain entity. The environmental impact of a supply chain entity may be the amount of airborne and/or waterborne emissions (e.g., SOx, COx, and NOx emissions) generated by the supply chain entity.

The property data may further include property data of the plurality of edges 150. For example, the property data may include mode of transport, transport capacity, transport volume, transport time, transport cost, tariff, energy price, environmental impact, etc., of each one of edges 150. The environmental impact of an edge may be the amount of airborne and/or waterborne emissions (e.g., SOx, COx, and NOx emissions) generated by the edge when the edge is used for transporting products or components. The amount of emissions can be estimated based on load weight, mode of transport, and distance traveled along the edge.

At step 304, processor 210 may acquire one or more business objectives to be achieved by supply chain 100. Processor 210 may acquire the one or more business objectives via user input, or from database 270 or storage 220. Examples of the desired business objectives may include minimizing demand response time, maximizing profit, maximizing return on net assets, minimizing inventory cost, maximizing inventory turns, maximizing service level, maximizing a resilience of supply chain 100, and minimizing the environmental impact.

At step 306, processor 210 may establish a first supply chain model for supply chain 100 in a first geographic resolution based on the property data acquired at step 302. The purpose of step 306 is to create a simplified supply chain model that has less supply chain entities and edges than the actual supply chain 100, and thus can be solved using relatively less amount of time.

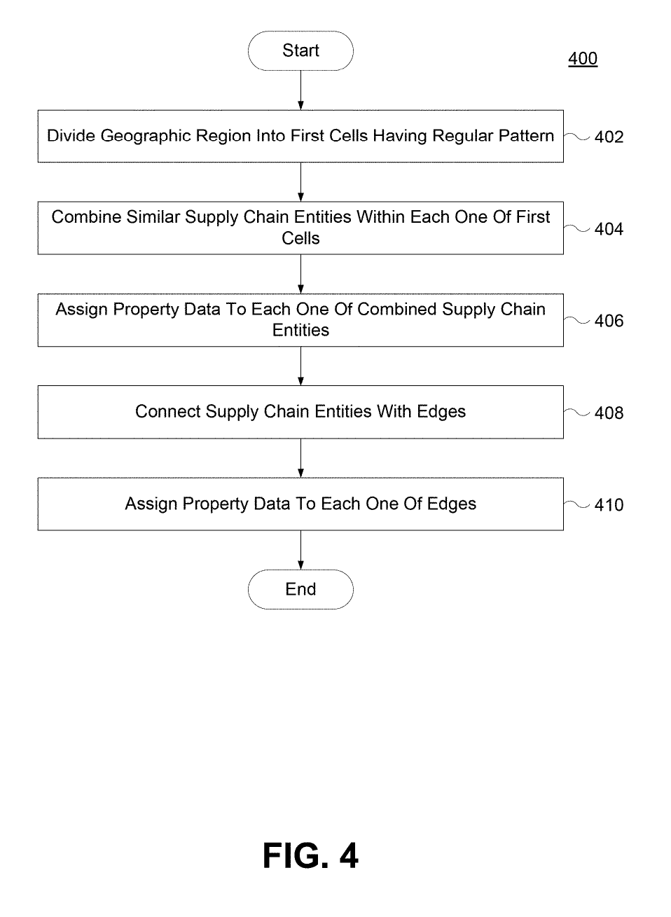

FIG. 4 illustrates a flow chart of an exemplary process 400 for establishing a first supply chain model, consistent with a disclosed embodiment. According to FIG. 4, processor 210 may first divide a geographic region where the plurality of supply chain entities in supply chain 100 are located, into a plurality of first cells having a regular pattern (step 402).

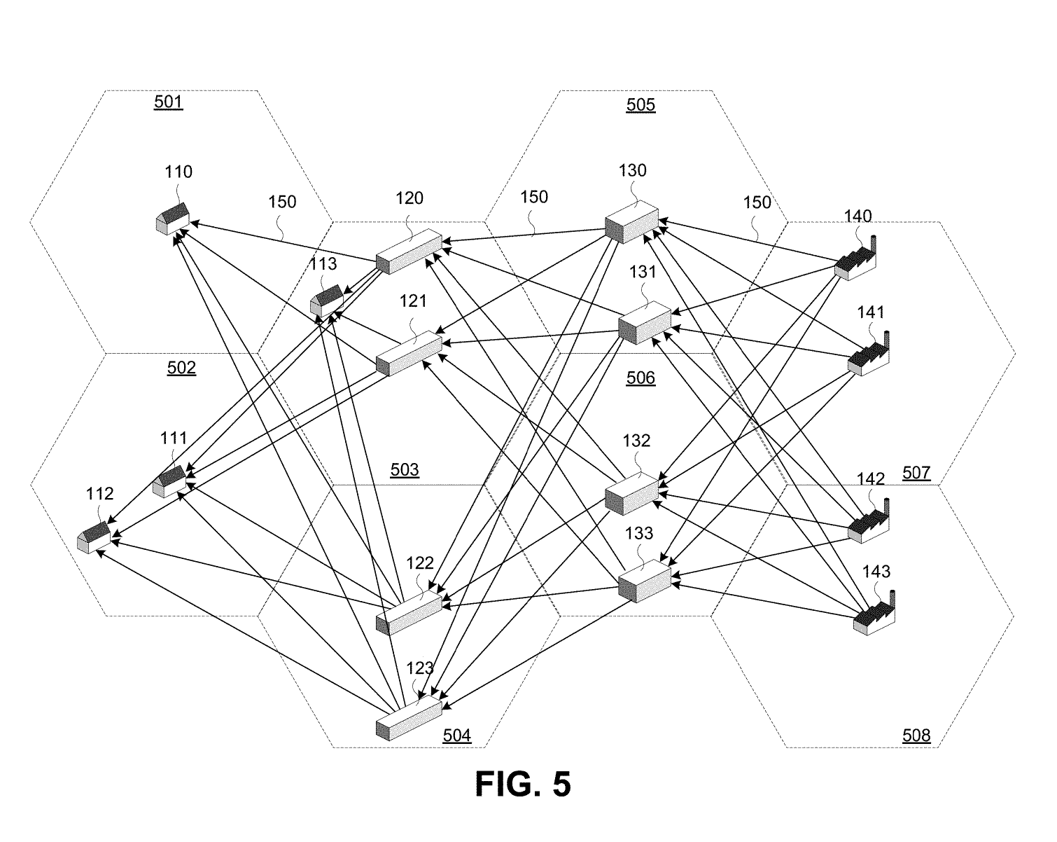

FIG. 5 illustrates a plurality of first cells 501-508 and supply chain 100, consistent with a disclosed embodiment. As illustrated in FIG. 5, the plurality of first cells 501-508 have a regular hexagonal shape with the same size. First cells 501-508 are arranged side by side with each other, and each pair of neighboring first cells have a common edge. For example, cells 501 and 502 have a common edge; cells 501 and 503 have a common edge; etc. The size and location of first cells 501-508 may be arbitrarily selected by a user or processor 210 based on the geographic locations and densities of the supply chain entities and available computing power. Because the purpose of establishing the first supply chain model is to create a simplified model with less supply chain entities and edges, the size of the first cells should be large enough to simplify supply chain 100, but small enough to separate the supply chain entities into a plurality of subsets of similar supply chain entities. In addition, if the available computing power is relatively large, the size of first cells 501-508 may be relatively large; and if the available computing power is relatively small, the size of first cells 501-508 may be relatively small. For example, the size and location of first cells 501-508 may be selected such that the total number of first cells 501-508 within the geographic region where the plurality of supply chain entities in supply chain 100 are located is greater or equal to a first threshold value, and the number of similar supply entities (i.e., the number of customers, the number of distributing facilities, or the number of manufacturing facilities) within each one of first cells 501-508 should be less or equal to a second threshold number.

Although the plurality of first cells 501-508 illustrated in FIG. 5 have a hexagonal shape with the same size, those skilled in the art will appreciate that the first cells can have different shapes and different sizes, as long as the first cells are arranged in a regular pattern. For example, the first cells may have a triangular shape, a rectangular shape, a square shape, etc. The first cells may also consist of a plurality of different types of polygons arranged in a regular pattern. For example, the first cells may consist of a plurality of regular hexagons and a plurality of regular pentagons arranged in a soccer ball pattern.

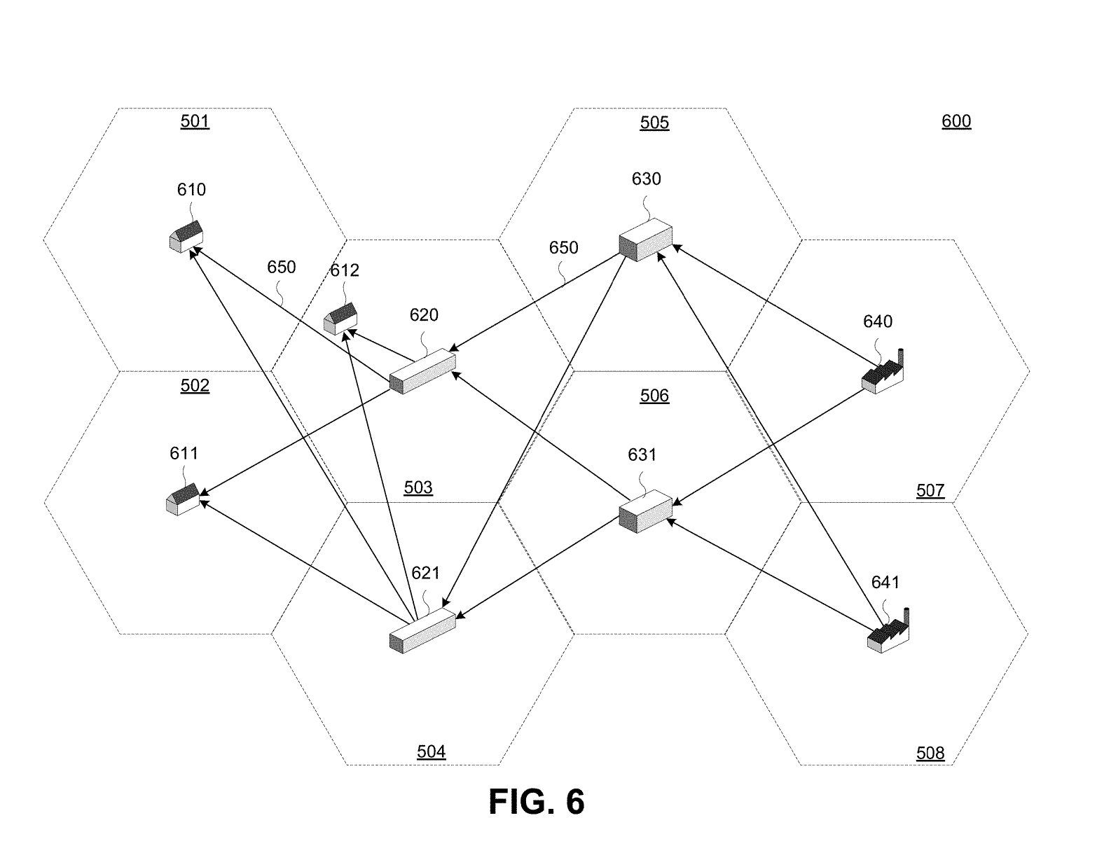

Referring back to FIG. 4, at step 404, processor 210 may combine similar supply chain entities within each one of first cells into a combined supply chain entity. FIG. 6 illustrates an exemplary first supply chain model 600 constructed by combining similar supply chain entities within each one of first cells 501-508, consistent with a disclosed embodiment. As shown in FIG. 6, first supply chain model 600 may include supply chain entities such as customers 610-612, inbound distributing facilities 620 and 621, outbound distributing facilities 630 and 631, and manufacturing facilities 640 and 641. At least one of the supply chain entities in first supply chain model 600 may be a combined supply chain entity resulting from combining two or more similar supply chain entities within one of first cells 501-508. For example, customer 611 in cell 502 may result from combining customers 111 and 112 in cell 502; inbound distributing facility 620 may result from a combination of inbound distributing facilities 120 and 121 in cell 502; and so on. If there is a single one of a certain type of supply chain entity, processor 210 may leave it as is. For example, as shown in FIG. 5, there is only one customer 113 in cell 503. Thus, as shown in FIG. 6, processor 210 may keep customer 113 as customer 612 in first supply chain model 600.

Referring back to FIG. 4, at step 406, processor 210 may assign property data to the combined supply chain entities based on the property data of each one of the similar supply chain entities constituting the combined supply chain entity. For example, if customer 111 demands for 100 products and customer 112 demands for 200 products in a given month, then processor 210 may determine that combined customer 611, which is a combination of customers 111 and 112, demands for 300 products in the given month. As another example, if a maximum production volume of each one of manufacturing facilities 140 and 141 is 150 products, then processor 210 may determine that a maximum production volume of combined manufacturing facility 640, which is a combination of manufacturing facilities 140 and 141, is 300 products in the given month.

At step 408, processor 210 may connect the plurality of supply chain entities with a plurality of edges. As shown in FIG. 6, the plurality of supply chain entities are connected by edges 650. Specifically, each one of customers 610-612 is connected to each one of inbound distributing facilities 620 and 621 by edges 650; each one of inbound distributing facilities 620 and 621 is connected to each one of outbound distributing facilities 630 and 631 by edges 650; and each one of outbound distributing facilities 630 and 631 is connected to each one of manufacturing facilities 640 and 641 by edges 650.

At step 410, processor 210 may assign property data to each one of the plurality of edges 650 in first supply chain model 600. Processor 210 may arbitrarily assign the property data of an edge 650 based on the size of first cells 501-508. For example, as shown in FIG. 6, the distance along an edge 650 between customer 610 in cell 501 and inbound distributing facility 620 in cell 503 may be determined as the radius of cell 501 plus the radius of cell 503. As another example, the distance along an edge 650 between customer 612 and inbound distributing facility 620, both of which being located in cell 503, may be determined as the radius of cell 503. Process 400 finishes after step 410.

Referring back to FIG. 3, once first supply chain model 600 is established, processor 210 may determine a first solution for first supply chain model 600 to fulfill demands at customers 610-612 and to achieve the one or more business objectives at step 308. That is, processor 210 may determine the first solution that, when implemented, will fulfill the demands at customers 610-612 and achieve the one or more business objectives. In particular, processor 210 may select one or more manufacturing facilities for manufacturing the products demanded by customers 610-612, determine a production plan (i.e., the number of products to be manufactured and/or held in inventory for each month) for each one of the selected manufacturing facilities. Processor 210 may also select one or more distributing facilities and edges for distributing the products from the selected manufacturing facilities to customers 610-612, and determine a transport plan (i.e., source, destination, route, time, mode of transportation, delivery volume, in-transit inventory, etc.) for delivering the products from the selected manufacturing facilities to customers 610-612 via the selected distributing facilities and edges. Processor 210 may also determine the inventory levels required in each of the supply chain entities throughout first supply chain model 600.

Processor 210 may determine the first solution by various methods known in the art. For example, processor 210 may apply a search tree method and/and an ant colony system optimization method.

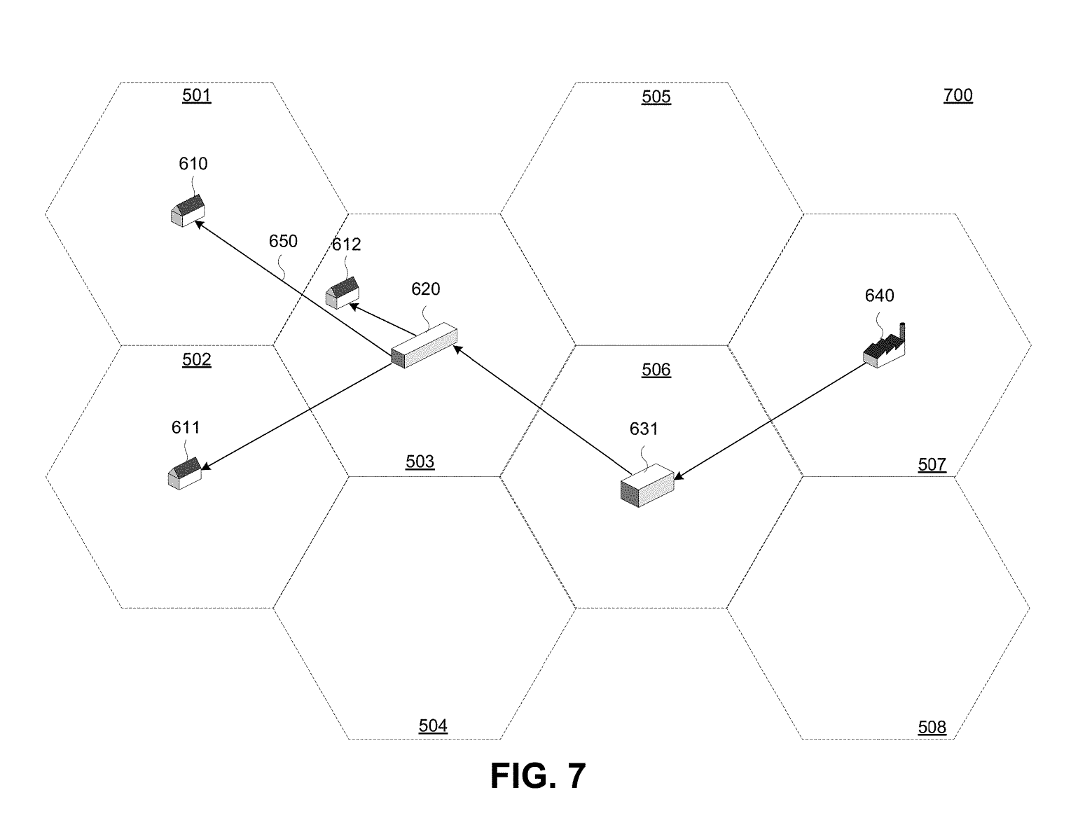

FIG. 7 illustrates an exemplary first solution 700 of first supply chain model 600, consistent with a disclosed embodiment. As illustrated in FIG. 7, first solution 700 may include customers 610-612, inbound distributing facility 620, outbound distributing facility 631, and manufacturing facility 640, a production plan of manufacturing facility 640, and a transportation plan for distributing the products from manufacturing facility 640 to customers 610-612. According to first solution 700, manufacturing facility 640 may manufacture and supply a certain number of products to outbound distributing facility 631. Outbound distributing facility 631 may deliver the certain number of products to inbound distributing facility 620. Inbound distributing facility 620 may distribute the products to customers 610-612.

Referring back to FIG. 3, at step 310, processor 210 may establish a second supply chain model for supply chain 100 in a second and finer geographic resolution based on first solution 700 determined for first supply chain model 600. The purpose of step 310 is create a supply chain model with all of the details necessary to provide an accurate and optimized design for supply chain 100.

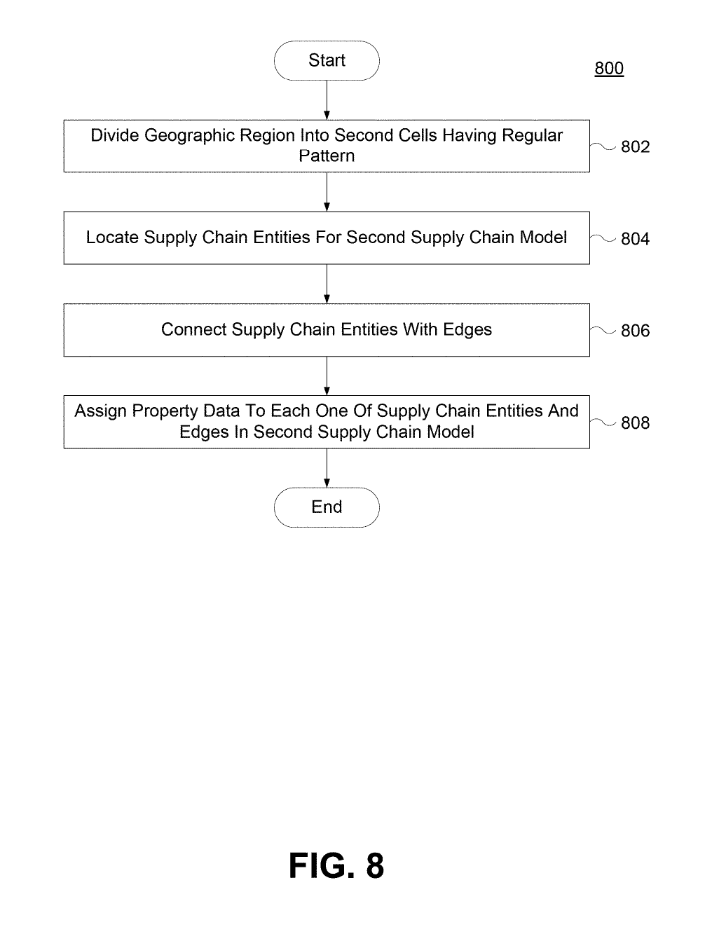

FIG. 8 illustrates a flow chart of an exemplary process 800 for establishing a second supply chain model, consistent with a disclosed embodiment. According to FIG. 8, processor 210 may first divide the geographic region where the plurality of supply chain entities in supply chain 100 are located into a plurality of second cells having a regular pattern at step 802.

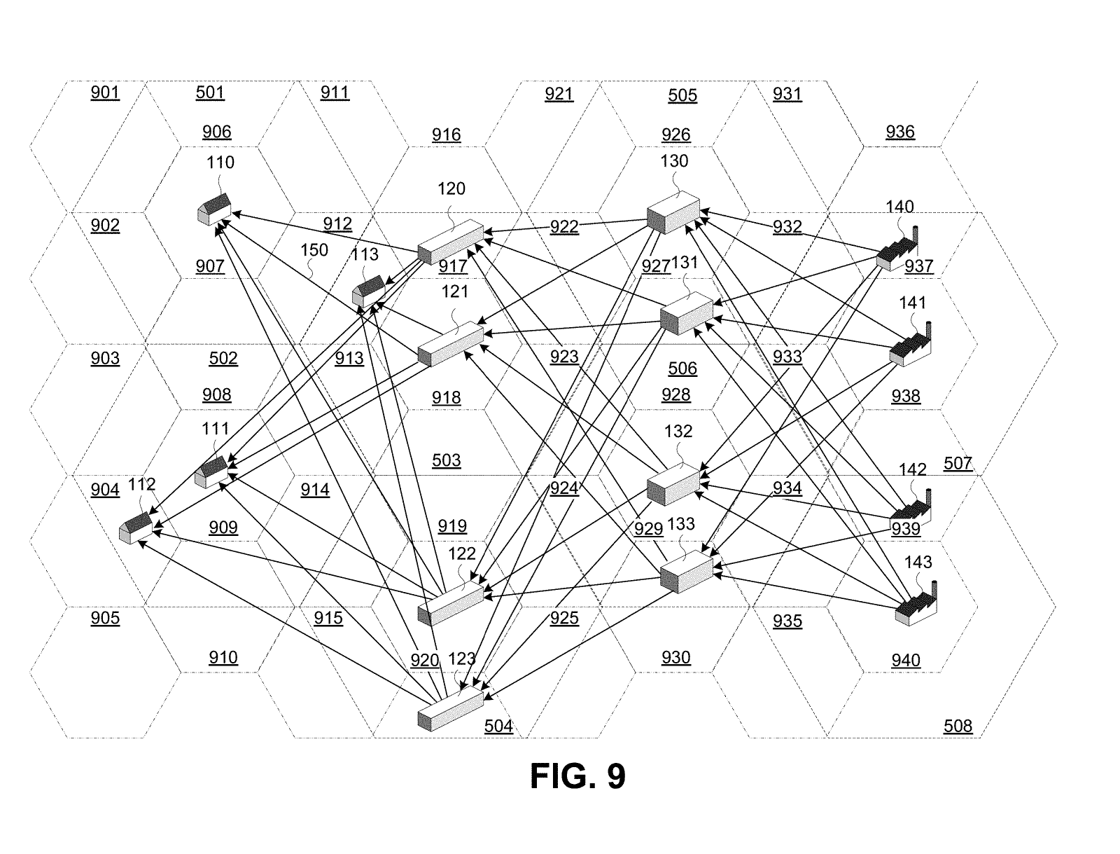

FIG. 9 illustrates a plurality of second cells 901-940, first cells 501-508, and supply chain 100, consistent with a disclosed embodiment. As illustrated in FIG. 9, the plurality of second cells 901-940 have a regular hexagonal shape with the same size. The size of second cells 901-940 are smaller than first cells 501-508. Second cells 901-940 are arranged side by side with each other, and each pair of neighboring second cells have a common edge. Similar to first cells 501-508, the size of second cells 901-940 may be selected by the user or processor 210 based on the geographic locations and densities of the supply chain entities included in supply chain 100 and available computing power. Because the purpose of establishing the second supply chain model is to include as much detail as possible to provide an accurate design for supply chain 100, the size of the second cells 901-940 should be small enough to differentiate the supply chain entities included in supply chain 100 from each other. For example, the size of second cells 901-940 may be selected such that the number of similar supply chain entities (i.e., the number of customers, the number of distributing facilities, or the number of manufacturing facilities) in supply chain 100 within each one of second cells 901-940 should be less or equal to a third threshold number, with the third threshold number being less than the second threshold number. In the example illustrated in FIG. 9, the number of similar supply chain entities in each one of second cells 901-940 is one (1).

In addition, the location of second cells 901-940 may be selected such that a center of each one of first cells 501-508 may overlap with a center of one of second cells 901-940. For example, as shown in FIG. 9, a center of first cell 501 overlaps with a center of second cell 907; a center of first cell 502 overlaps with a center of second cell 909; and so on. The overlapping centers may serve as “anchor points” where the first solution for the first supply chain model and the second solution for the second supply chain model meet.

Although the plurality of second cells 901-940 illustrated in FIG. 9 have a hexagonal shape with the same size, those skilled in the art will appreciate that the second cells can have different shapes and different sizes, as long as the second cells are arranged in a regular pattern, and a center of at least one second cell overlaps with a center of a first cell. For example, the second cells may have a triangular shape, a rectangular shape, a square shape, etc., or may consist of different types of polygons arranged in a regular pattern.

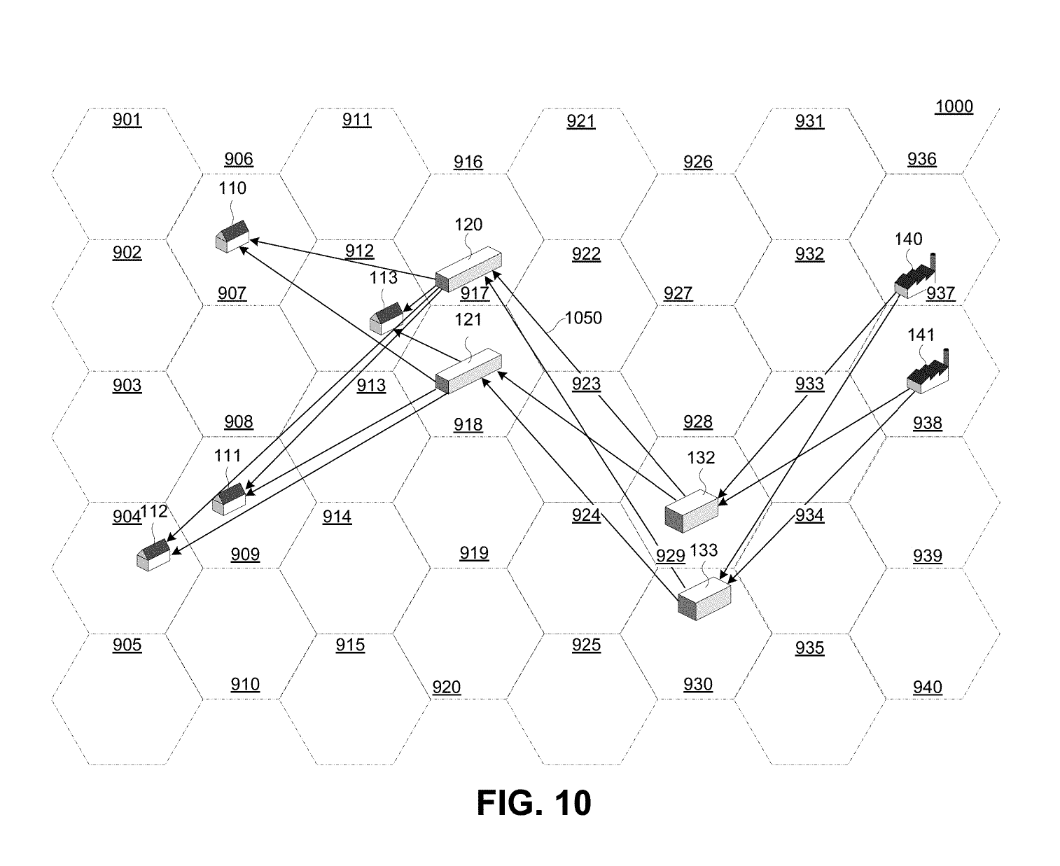

Referring back to FIG. 8, processor 210 may locate supply chain entities for the second supply chain model (step 804). In one embodiment, processor 210 may map all of the supply chain entities in supply chain 100 into the second cells (as illustrated in FIG. 9), and delete the supply chain entities that are not related to first solution 700. In particular, processor 210 may delete the supply chain entities in each of first cells 501-508 that does not contain any similar supply chain entity in first solution 700. For example, as illustrated in FIG. 7, because first solution 700 does not include any inbound distributing entity in first cell 504, processor 210 may delete inbound distributing entities 122 and 123 in first cell 504. As another example, as illustrated in FIG. 7, because first solution 700 does not include any manufacturing facility in first cell 508, processor 210 may delete manufacturing facilities 142 and 143 in first cell 508. FIG. 10 schematically illustrates an exemplary second supply chain model 1000 resulting from the above-described method, consistent with a disclosed embodiment.

In another embodiment, processor 210 may map first solution 700 into second cells 901-940 and then separate each one of combined supply chain entities in first solution 700. For example, referring to FIG. 7, processor 210 may map first solution 700 including customers 610-612, the selected manufacturing facility 640, and the selected distributing facilities 620 and 631 into second cells 901-940. If any one of the supply chain entities in first solution 700 is a combined supply chain entity, processor 210 may separate the combined supply chain entity back into the two or more similar supply chain entities constituting the combined supply chain entity. For example, referring to FIG. 7, because customer 611 in first solution 700 is a combined supply chain entity resulting from combining customer 111 and 112, processor 210 may separate customer 611 back into customers 111 and 112. As another example, because outbound distributing facility 631 in first solution 700 is a combined supply chain entity resulting from combining outbound distributing facilities 132 and 133, processor 210 may separate outbound distributing facility 631 back into outbound distributing facilities 132 and 133. This method will result in the same supply chain model as second supply chain model 1000 illustrated in FIG. 10.

Once the supply chain entities in second supply chain model 1000 are located, processor 210 may connect the supply chain entities in second supply chain model 1000 with a plurality of edges 1050 (step 806). As shown in FIG. 10, the plurality of supply chain entities are connected by edges 1050. Specifically, each one of customers 110-113 is connected to each one of inbound distributing facilities 120 and 121 by edges 1050; each one of inbound distributing facilities 120 and 121 is connected to each one of outbound distributing facilities 132 and 133 by edges 1050; and each one of outbound distributing facilities 132 and 133 is connected to each one of manufacturing facilities 140 and 141 by edges 1050.

Processor 210 may then assign property data to each one of the supply chain entities and edges based on the in first solution 700 (step 808). In particular, processor 210 may assign property data to each one of the supply chain entities based on the production plan and transport plan included in first solution 700. For example, referring to FIG. 10, if, according to first solution 700, combined manufacturing facility 640, which is a combination of manufacturing facilities 140 and 141, manufactures 250 products, then processor 210 may determine that manufacturing facilities 140 and 141 in second supply chain model 1000 together manufacture 250 products. In addition, processor 210 may assign property data to each one of edges 1050 based on the property data originally acquired at step 302. For example, processor 210 may assign mode of transport, transport capacity, transport volume, transport time, transport cost, tariff, energy price, environmental impact, etc., to each one of edges 1050. Process 800 finishes after step 808.

Referring back to FIG. 3, once the second supply chain model is established, processor 210 may determine a second solution for second supply chain model 1000 to fulfill demands at customers 610-612 and to achieve the one or more business objectives (step 312). That is, processor 210 may determine the first solution that, when implemented, will fulfill the demands at customers 110-113 and achieve the one or more business objectives. In particular, processor 210 may select one or more manufacturing facilities for manufacturing the products demanded by customers 110-113, determine a production plan (i.e., the number of products to be manufactured and/or held in inventory for each month) for each one of the selected manufacturing facilities. Processor 210 may also select one or more distributing facilities and edges for distributing the products from the selected manufacturing facilities to customers 110-113, and determine a transport plan (i.e., source, destination, route, time, mode of transportation, delivery volume, in-transit inventory, etc.) for delivering the products from the selected manufacturing facilities to customers 110-113 via the selected distributing facilities and edges. Processor 210 may also determine the inventory levels required in each of the supply chain entities throughout second supply chain model 1000. Similar to step 308 for determining the first solution, processor 210 may determine the second solution by various methods known in the art. For example, processor 210 may apply a search tree method and/and an ant colony system optimization method.

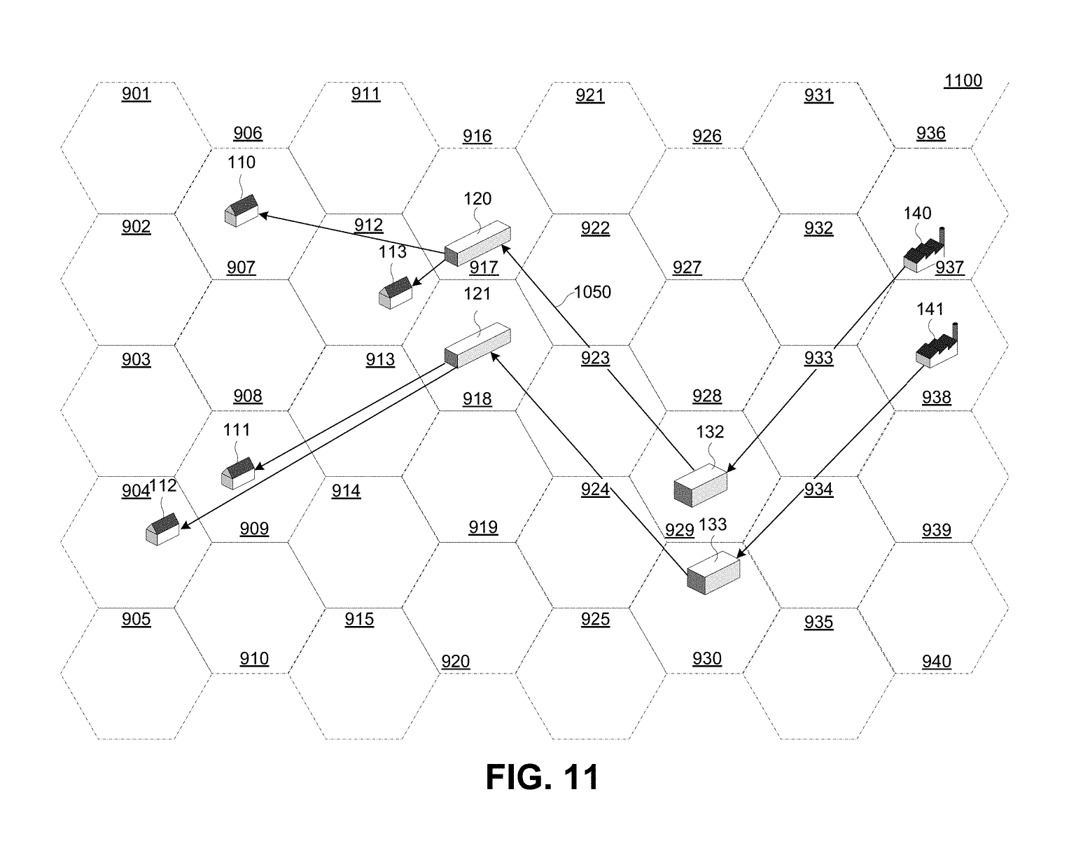

FIG. 11 illustrates an exemplary second solution 1100 of second supply chain model 1000, consistent with a disclosed embodiment. As illustrated in FIG. 11, according to second solution 1100, manufacturing facility 140 may manufacture and supply a first number of products to outbound distributing facility 132, which may deliver the first number of products to inbound distributing facility 120, which may distribute the first number products to customers 110 and 113 according to their respective demands. In addition, according to second solution 1100, manufacturing facility 141 may manufacture and supply a second number of products to outbound distributing facility 133, which may deliver the second number of products to inbound distributing facility 121, which may distribute the second number products to customers 111 and 112 according to their respective demands.

At step 314, processor 210 may output the second solution and manage supply chain 100 based on the second solution. For example, processor 210 may automatically generate a report of production plans for each of manufacturing facilities 140 and 141. As another example, processor 210 may generate a graphical representation (e.g., a map) showing all of the supply chain entities and all of the distribution routes for distributing the products and components. Then, supply chain 100 may be managed by configuring the physical placement, dimensions, and internal structures of the supply chain entities, including inbound distributing facilities 120 and 121, outbound distributing facilities 132 and 133, and manufacturing facilities 140 and 141. For example, based on the determined production plans of manufacturing facilities 140 and 141, processor 210 may configure the physical placements, dimensions, and internal structures of manufacturing facilities 140 and 141, and the physical placement of the inventory of finished products and components to be used for manufacturing the products within manufacturing facilities 140 and 141. In addition, processor 210 may configure the arrangement of transport entities (e.g., airplanes, trains, trucks, boats, etc.) between the supply chain entities based on the transport plan. In this way, the design of supply chain 100 optimized by the supply chain model can be successfully implemented in the production and delivery of products. Process 300 finishes after step 314.

Although process 300 in the embodiment illustrated in FIG. 3 models the supply chain using two different resolutions, process 300 may model the supply chain using more than two resolutions, starting from the coarsest solution to the finest solution.

In addition, when establishing a supply chain model, different resolutions can be applied to different types of supply chain entities. For example, when establishing the first supply chain model at step 306, a coarse resolution may be applied to manufacturing facilities and distributing facilities, while a fine or ultra-fine resolution may be applied to customers.

Furthermore, it will be apparent to those skilled in the art that processes 300, 400, and 800 are not limited to the embodiments illustrated in FIGS. 3, 4, and 8. That is, each one of processes 300, 400, and 800 may include one or more of steps illustrated in the corresponding figure. In addition, each one of processes 300, 400, and 800 may include one or more additional steps. Moreover, the sequence of the steps in each one of processes 300, 400, and 800 is not limited to the embodiments illustrated in FIGS. 3, 4, and 8. For example, instead of performing step 408 after step 406 in the embodiment illustrated in FIG. 4, step 408 may be performed before step 406.

The method and system for supply chain management disclosed herein may have distinct advantages over conventional art. First, the method of the disclosed embodiments first models a complex and massive supply chain using a coarse resolution and solves the model, and then models the supply chain using a finer resolution and applies the solution for the coarse model to solve the fine model. Thus, compared to a conventional method of solving a complex supply chain problem with a fine resolution, the process for finding the solution for the supply chain management problem may be accelerated. This is extremely advantageous because the dynamic environment, such as volatile energy prices, may require finding the solution fast enough to manage the supply chain dynamically.

In addition, the method of the disclosed embodiments takes the environmental impact (such as SOx, Cox, and NOx emissions) as a factor when determining the solution for the supply chain. This allows for reduction of the supply chain's airborne and waterborne emissions, while still meeting the demands of the customers and various business objectives of the business organization.

It will be apparent to those skilled in the art that various modifications and variations can be made to the disclosed supply chain management method and system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A method for managing a supply chain, comprising:
acquiring property data regarding the supply chain, the supply chain including a plurality of supply chain entities including a plurality of customers with demands for products, a plurality of manufacturing facilities for manufacturing the products, and a plurality of distributing facilities for distributing the products from the manufacturing facilities to the customers, and a plurality of edges connecting the plurality of supply chain entities;
acquiring one or more objectives to be achieved by the supply chain;
establishing a first supply chain model for the supply chain in a first geographic resolution based on the property data;
determining a first solution for the first supply chain model to fulfill demands and achieve the one or more objectives;
establishing a second supply chain model for the supply chain in a second and finer geographic resolution based on the first solution for the first supply chain model;
determining a second solution for the second supply chain model to fulfill the demands and achieve the one or more objectives;
manufacturing products by the manufacturing facilities based on the second solution; and
distributing the manufactured products by the distributing facilities and edges based on the second solution.

2. The method of claim 1, wherein the property data regarding the supply chain includes property data regarding each one of the supply chain entities and each one of the edges,
the property data including a factor of environmental impact.

3. The method of claim 1, wherein the one or more objectives include minimizing environmental impact of the supply chain.

4. The method of claim 1, wherein establishing a first supply chain model for the supply chain in a first geographic resolution based on the property data includes:
dividing a geographic region where the plurality of supply chain entities are located into a plurality of first cells having a regular pattern;
combining similar supply chain entities within each cell into a combined supply chain entity;
assigning property data to the combined supply chain entities based on the property data of each one of the similar supply chain entities constituting the combined supply chain entity;
connecting the supply chain entities with a plurality of edges; and
assigning property data to each edge based on a size of the first cells.

5. The method of claim 4, wherein determining a first solution for the first supply chain model to fulfill demands and achieve the one or more objectives includes:
selecting a first subset of manufacturing facilities for manufacturing the products;
determining a production plan for each manufacturing facility in the first subset of manufacturing facilities;
selecting a first subset of distributing facilities and a first subset of edges for distributing the products from the first subset of manufacturing facilities to the customers; and
determining a transportation plan for delivering the products from the first subset of manufacturing facilities to the customers via the first subset of distributing facilities and first subset of edges.

6. The method of claim 5, wherein establishing a second supply chain model for the supply chain in a second and finer geographic resolution based on the first solution for the first supply chain model includes:
dividing the geographic region where the plurality of supply chain entities of the supply chain are located into a plurality of second cells having a second regular pattern, the size of the second cells being smaller than the size of the first cells;
locating supply chain entities for the second supply chain model;
connecting the supply chain entities with a plurality of edges; and
assigning property data to each one of the supply chain entities and edges based on the first solution.

7. The method of claim 6, wherein determining a second solution for the second supply chain model to fulfill the demands and achieve the one or more objectives includes:
selecting a second subset of manufacturing facilities for manufacturing the products;
determining a production plan for each manufacturing facility in the second subset of manufacturing facilities;
selecting a second subset of distributing facilities and a second subset of edges for distributing the products from the subset of manufacturing facilities to the customers; and
determining a transportation plan for each distributing facility in the second subset of distributing facilities and for each edge in the second subset of edges.

8. The method of claim 1, further including:
configuring physical placement, dimension, and internal structure of each of the supply chain entities based on the second solution; and
configuring arrangement of transport entities between the supply chain entities based on the second solution.

9. A supply chain, comprising:
a plurality of supply chain entities including a plurality of customers with demands for products, a plurality of manufacturing facilities for manufacturing the products, and a plurality of distributing facilities for distributing the products from the manufacturing facilities to the customers, and a plurality of edges connecting the plurality of supply chain entities;
a processor configured to:
acquire property data regarding the supply chain;
acquire one or more objectives to be achieved by the supply chain;
establish a first supply chain model for the supply chain in a first geographic resolution based on the property data;
determine a first solution for the first supply chain model to fulfill demands and achieve the one or more objectives;
establish a second supply chain model for the supply chain in a second and finer geographic resolution based on the first solution for the first supply chain model;
determine a second solution for the second supply chain model to fulfill the demands and achieve the one or more objectives;
configuring physical placement, dimension, and internal structure of each of the supply chain entities based on the second solution; and
configuring arrangement of transport entities between the supply chain entities based on the second solution.

10. The supply chain of claim 9, wherein the property data regarding the supply chain includes a factor of environmental impact regarding each one of the supply chain entities and each one of the edges, and
the one or more objectives include minimizing environmental impact of the supply chain.

11. The supply chain of claim 9, wherein the processor is configured to, when establishing the first supply chain model for the supply chain in the first geographic resolution based on the property data:
divide a geographic region where the plurality of supply chain entities are located into a plurality of first cells having a regular pattern;
combine similar supply chain entities within each cell into a combined supply chain entity;
assign property data to the combined supply chain entities based on the property data of each one of the similar supply chain entities constituting the combined supply chain entity;
connect the supply chain entities with a plurality of edges; and
assign property data to each edge based on a size of the first cells.

12. The supply chain of claim 11, wherein the processor is configured to, when determining the first solution for the first supply chain model to fulfill the demands and achieve the one or more objectives:
select a first subset of manufacturing facilities for manufacturing the products;
determine a production plan for each manufacturing facility in the first subset of manufacturing facilities;
select a first subset of distributing facilities and a first subset of edges for distributing the products from the first subset of manufacturing facilities to the customers; and
determine a transportation plan for delivering the products from the first subset of manufacturing facilities to the customers via the first subset of distributing facilities and first subset of edges.

13. The supply chain of claim 12, wherein the processor is configured to, when establishing the second supply chain model for the supply chain in the second and finer geographic resolution based on the first solution for the first supply chain model:
divide the geographic region where the plurality of supply chain entities of the supply chain are located into a plurality of second cells having a second regular pattern, the size of the second cells being smaller than the size of the first cells;
locate supply chain entities for the second supply chain model;
connect the supply chain entities with a plurality of edges; and
assign property data to each one of the supply chain entities and edges based on the first solution.

14. The supply chain of claim 13, wherein the processor is configured to, when determining the second solution for the second supply chain model to fulfill the demands and achieve the one or more objectives:
select a second subset of manufacturing facilities for manufacturing the products;
determine a production plan for each manufacturing facility in the second subset of manufacturing facilities;
select a second subset of distributing facilities and a second subset of edges for distributing the products from the subset of manufacturing facilities to the customers; and
determine a transportation plan for each distributing facility in the second subset of distributing facilities and for each edge in the second subset of edges.

15. A supply chain management system, comprising:
a processor; and
a non-transitory memory configured to store instructions that, when executed, enable to the processor to:
acquire property data regarding the supply chain, the supply chain including a plurality of supply chain entities including a plurality of customers with demands for products, a plurality of manufacturing facilities for manufacturing the products, a plurality of distributing facilities for distributing the products from the manufacturing facilities to the customers, and a plurality of edges connecting the plurality of supply chain entities;
acquire one or more objectives to be achieved by the supply chain;
establish a first supply chain model for the supply chain in a first geographic resolution based on the property data;
determine a first solution for the first supply chain model to fulfill demands and achieve the one or more objectives;
establish a second supply chain model for the supply chain in a second and finer geographic resolution based on the first solution for the first supply chain model;
determine a second solution for the second supply chain model to fulfill the demands and achieve the one or more objectives;
configure physical placement, dimension, and internal structure of each of the supply chain entities based on the second solution; and
configure arrangement of transport entities between the supply chain entities based on the second solution.

16. The system of claim 15, wherein the property data regarding the supply chain includes a factor of environmental impact regarding each one of the supply chain entities and each one of the edges, and
the one or more objectives include minimizing environmental impact of the supply chain.

17. The system of claim 15, wherein the instructions stored in the memory further enable the processor to, when establishing the first supply chain model for the supply chain in the first geographic resolution based on the property data:
divide a geographic region where the plurality of supply chain entities are located into a plurality of first cells having a regular pattern;
combine similar supply chain entities within each cell into a combined supply chain entity;
assign property data to the combined supply chain entities based on the property data of each one of the similar supply chain entities constituting the combined supply chain entity;
connect the supply chain entities with a plurality of edges; and
assign property data to each edge based on a size of the first cells.

18. The system of claim 17, wherein the instructions stored in the memory further enable the processor to, when determining the first solution for the first supply chain model to fulfill the demands and achieve the one or more objectives:
select a first subset of manufacturing facilities for manufacturing the products;
determine a production plan for each manufacturing facility in the first subset of manufacturing facilities;
select a first subset of distributing facilities and a first subset of edges for distributing the products from the first subset of manufacturing facilities to the customers; and
determine a transportation plan for delivering the products from the first subset of manufacturing facilities to the customers via the first subset of distributing facilities and first subset of edges.

19. The system of claim 18, wherein the instructions stored in the memory further enable the processor to, when establishing the second supply chain model for the supply chain in the second and finer geographic resolution based on the first solution for the first supply chain model:
divide the geographic region where the plurality of supply chain entities of the supply chain are located into a plurality of second cells having a second regular pattern, the size of the second cells being smaller than the size of the first cells;
locate supply chain entities for the second supply chain model;
connect the supply chain entities with a plurality of edges; and
assign property data to each one of the supply chain entities and edges based on the first solution.

20. The system of claim 18, wherein the instructions stored in the memory further enable the processor to, when determining the second solution for the second supply chain model to fulfill the demands and achieve the one or more objectives:
select a second subset of manufacturing facilities for manufacturing the products;
determine a production plan for each manufacturing facility in the second subset of manufacturing facilities;
select a second subset of distributing facilities and a second subset of edges for distributing the products from the subset of manufacturing facilities to the customers; and
determine a transportation plan for each distributing facility in the second subset of distributing facilities and for each edge in the second subset of edges.
